(19) United States
(12) Patent Application Publication
(10) Pub. No.: US 2014/0153836 A1
(43) Pub. Date: Jun. 5, 2014

(54) ELECTRONIC DEVICE AND IMAGE PROCESSING METHOD

(71) Applicant: Kabushiki Kaisha Toshiba, Tokyo (JP)

(72) Inventor: Yoshikata Tobita, Nishitokyo-shi (JP)

(21) Appl. No.: 13/919,694

(22) Filed: Jun. 17, 2013

(30) Foreign Application Priority Data
Nov. 30, 2012 (JP) 2012-262872

(51) Int. Cl. G06T 13/00

(52) U.S. Cl. CPC G06T 13/00
USPC 382/218

(57) ABSTRACT

According to one embodiment, an electronic device includes an analyzer, an image selector, an effect selector and a generator. The analyzer is configured to analyze an attribute of each of a plurality of images. The image selector is configured to select, from the plurality of images, a first image which comprises a target and a second image which does not comprise the target, based on the attribute. The effect selector is configured to select a first effect, and to select a second effect. The generator is configured to generate a moving picture by compositing a third image obtained by applying the first effect to the first image, and a fourth image obtained by applying the second effect to the second image.

### CROSS-REFERENCE TO RELATED APPLICATIONS

This application is based upon and claims the benefit of priority from Japanese Patent Application No. 2012-262872, filed Nov. 30, 2012, the entire contents of which are incorporated herein by reference.

### FIELD

Embodiments described herein relate generally to an electronic device which displays an image and an image processing method.

### BACKGROUND

In recent years, various electronic devices, such as a personal computer, a digital camera, a smartphone, a mobile phone and an electronic book reader, have been gaining in popularity. Such electronic devices have, for example, functions of managing still images such as photos. As an image management method, for example, there is known a method of classifying photos into a plurality of groups, based on date/time data added to the photos.

In addition, recently, attention has been paid to a moving picture creation technique of creating a moving picture (e.g. photo movie, slide show) by using still images such as photos. As the moving picture creation technique, for example, there is known a technique of classifying still images into a plurality of directories corresponding to a plurality of photographing dates/times, storing the classified still images, and creating a moving picture by using the still images in a directory designated by a user.

In the conventional technique, with respect to a scenario in which a plurality of effects, which are prepared in advance, are arranged, an image material, to which each effect is applicable, is extracted. Thus, when the number of images included in a still image group is large or the number of images, to which effects are applicable, is small, a processing load for extracting the image material increases, and the time needed for the processing becomes longer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device of an embodiment.

FIG. 2 is an exemplary view illustrating a system configuration of the electronic device of the embodiment.

FIG. 3 is an exemplary block diagram illustrating a functional configuration which is realized by a composite moving picture generation program in the embodiment.

FIG. 4 is a view illustrating an example of analysis information which is stored in a material database in the embodiment.

FIG. 5 is a view illustrating an example of a style select screen in the embodiment.

FIG. 6 is a view illustrating an example of material information indicative of characteristics of image material corresponding to styles in the embodiment.

FIG. 7 is a view illustrating scenarios which are prepared for respective styles in the embodiment.

FIG. 8 is a view illustrating an example of one scenario in the embodiment.

FIG. 9 is an exemplary flowchart illustrating a composite moving picture generation process by the composite moving picture generation program in the embodiment.

FIG. 10 is a view illustrating an example of analysis information which is stored in the material database in the embodiment.

FIG. 11 is a view illustrating a selection result by a material select module in the embodiment.

FIG. 12 is a view for explaining selection of effects by an effect select module in the embodiment.

FIG. 13 is a view illustrating a selection result of effects by the effect select module in the embodiment.

FIG. 14 is a view illustrating an example of composite moving picture information which is notified to a composite moving picture generation module in the embodiment.

FIG. 15 is a view illustrating a scene of a moving picture which is composited in the embodiment.

FIG. 16 is a view illustrating a scene of a moving picture which is composited in the embodiment.

### DETAILED DESCRIPTION

Various embodiments will be described hereinafter with reference to the accompanying drawings.

In general, according to one embodiment, an electronic device comprises an analyzer, an image selector, an effect selector and a generator. The analyzer is configured to analyze an attribute of each of a plurality of images. The image selector is configured to select, from the plurality of images, a first image which comprises a target and a second image which does not comprise the target, based on the attribute. The effect selector is configured to select a first effect, and to select a second effect. The generator is configured to generate a moving picture by compositing a third image obtained by applying the first effect to the first image, and a fourth image obtained by applying the second effect to the second image.

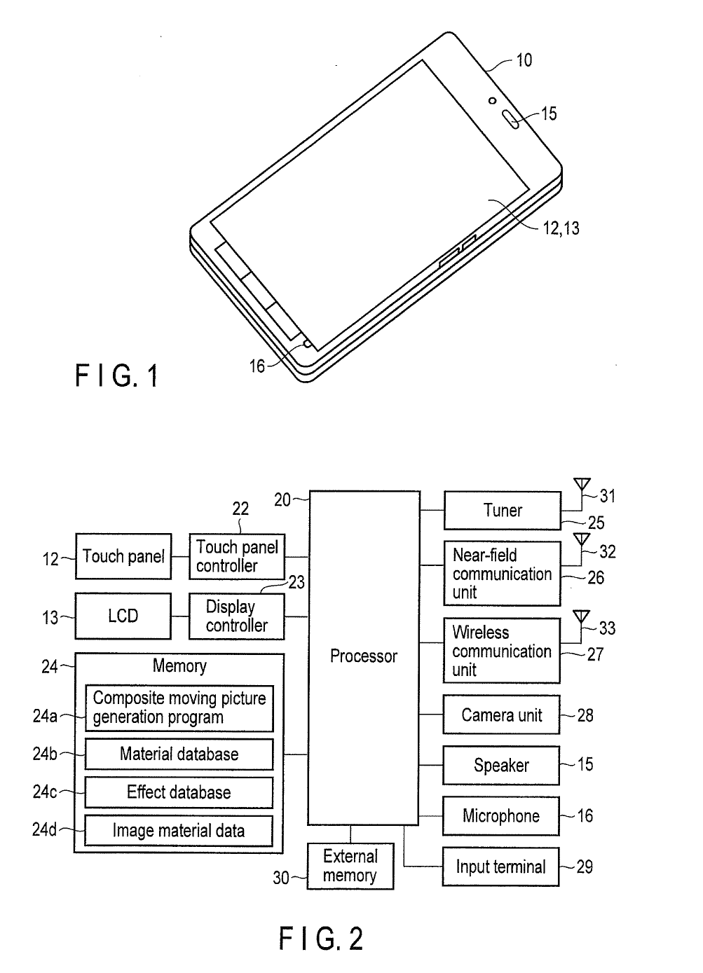

FIG. 1 is a perspective view illustrating the external appearance of an electronic device 10 according to an embodiment. The electronic device 10 is realized, for example, as a smartphone. Incidentally, the electronic device 10 is not limited to the smartphone, and may be some other device such as a notebook-type or tablet-type personal computer, a television device, a car navigation device, a digital camera, a mobile phone, or an electronic book reader.

The electronic device 10 has a thin box-shaped housing, and a touch-screen panel is provided on a top surface of the housing. The touch-screen panel is a device in which a touch panel 12 and an LCD (Liquid Crystal Display) 13 are integrated. In addition, a speaker 15 and a microphone 16 are provided on the top surface of the housing. Besides, a plurality of buttons, to which specific functions are assigned, are provided on a top surface portion or a side surface portion of the housing of the electronic device 10. Although not illustrated, a camera unit for capturing images is provided on a back surface of the housing of the electronic device 10.

FIG. 2 is a view illustrating a system configuration of the electronic device 10.

As shown in FIG. 2, in the electronic device 10, a touch panel controller 22, a display controller 23, a memory 24, a tuner 25, a near-field communication unit 26, a wireless communication unit 27, a camera unit 28, an input terminal 29, an external memory 30, speaker 15 and microphone 16 are connected to a processor 20.

The processor 20 executes various application programs, as well as a basic program which controls the respective units. The processor 20 can execute not only pre-registered application programs, but also application programs which are input via the wireless communication unit 27, input terminal 29 and external memory 30. The processor 20 executes an application program, such as a composite moving picture generation program 24a, which is stored, for example, in the memory 24. By executing the composite moving picture generation program 24a, the processor 20 realizes a function of generating a moving picture, based on images which are stored in the memory 24 or external memory 30, or images which are received from an external device via the near-field communication unit 26 or input terminal 29. A moving picture, which is generated by the composite moving picture generation program 24a, can be displayed on the LCD 13 or stored as a moving picture file.

The touch panel controller 22 controls an input on the touch panel 12. The display controller 23 controls display of the LCD. The touch screen panel is constructed by integrating the touch panel 12 and LCD 13.

The memory 24 stores various programs and data. The memory 24 stores, for example, a composite moving picture generation program 24a, and data such as a material database 24b, an effect database 24c and an image material data 24d, which are used in a process by the composite moving picture generation program 24a. The image material data 24d is data including a plurality of images (still images, moving picture) which become the material of moving picture generation by the composite moving picture generation program 24a. The material database 24b is data indicative of a result (analysis information) of analysis of attributes (e.g. image characteristics) of the images included in the image material data 24d. The effect database 24c is data indicative of an image effect process which is executed on the images included in the material database 24b in order to generate a moving picture. It is assumed that in the effect database 24c, for example, a plurality of scenarios are prepared for each of a plurality of styles for classifying characteristics of images. In the scenario, a plurality of effects (single effects, or effect series) are defined in a predetermined order in which the effects are used in an image effect process. Furthermore, it is assumed that the effect database 24c of the embodiment includes scenarios (target-of-interest scenarios) which are used for images including a target of interest (e.g. an image designated by the user), and scenarios (general scenarios) which are used for images not including the target of interest.

The tuner 25 receives a broadcast signal for TV broadcast via an antenna 31. The near-field communication unit 26 is a unit for controlling communication by a wireless LAN (Local Area Network), and transmits/receives a signal for near-field communication via an antenna 32.

The wireless communication unit 27 is a unit for a connection to a public network, and transmits/receives via an antenna 33 a communication signal to/from a base station which is accommodated in the public network.

The camera unit 28 is a unit for capturing still images or a moving picture. The still images, which are captured by the camera unit 28, can be stored in the memory 24 as the image material data 24d for moving picture generation by the composite moving picture generation program 24a.

The input terminal 29 is a terminal for a connection to an external electronic device via a cable or the like. The electronic device 10 can input image data, etc. from some other electronic device via the input terminal 29. Image data, which is input from the input terminal 29, can be stored in the memory 24 as the image material data 24d for moving picture generation by the composite moving picture generation program 24a.

The external memory 30 is a storage medium which is detachably attached to, for example, a slot (not shown) provided in the electronic device 10. The electronic device 10 reads out images which are stored in the external memory 30, and can store the images in the memory 24 as the image material data 24d for moving picture generation by the composite moving picture generation program 24a.

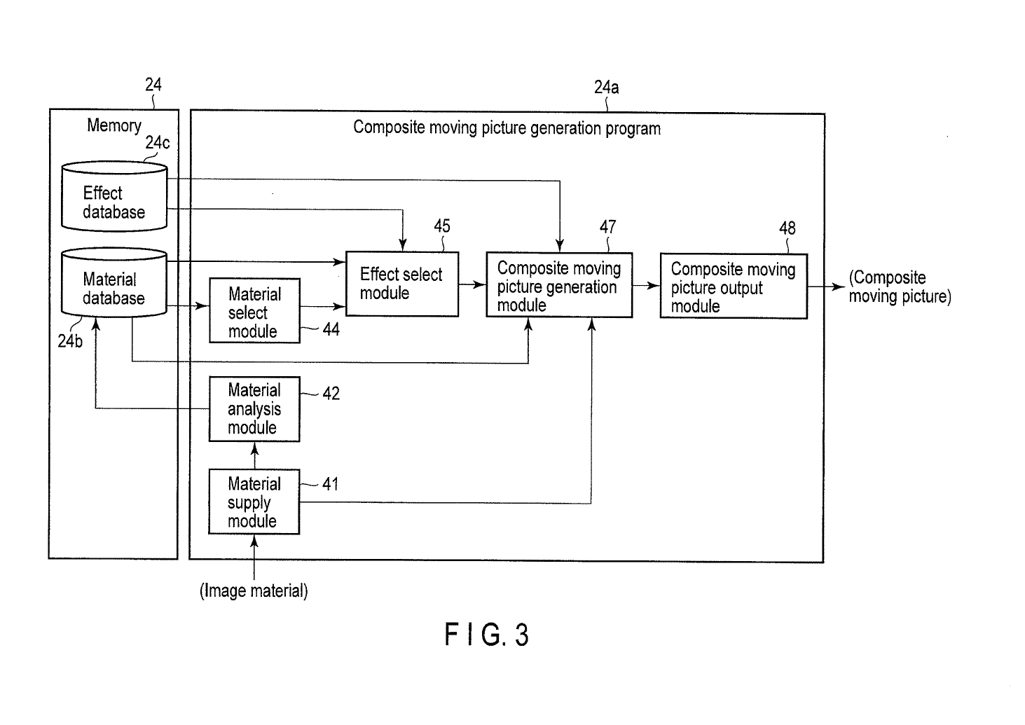

Next, referring to FIG. 3, a description is given of a functional configuration which is realized by the composite moving picture generation program 24a in the embodiment.

The composite moving picture generation program 24a is executed by the processor 20, thereby realizing functions of a material supply module 41, a material analysis module 42, a material select module 44, an effect select module 45, a composite moving picture generation module 47 and a composite moving picture output module 48.

The material supply module 41 inputs image material (image data) for moving picture generation, and stores the image material in the memory 24 as the image material data 24d. The material supply module 41 can input as the image material, for example, images captured by the camera unit 28, images read out from the external memory 30, and images which are input from an external device via the input terminal 29.

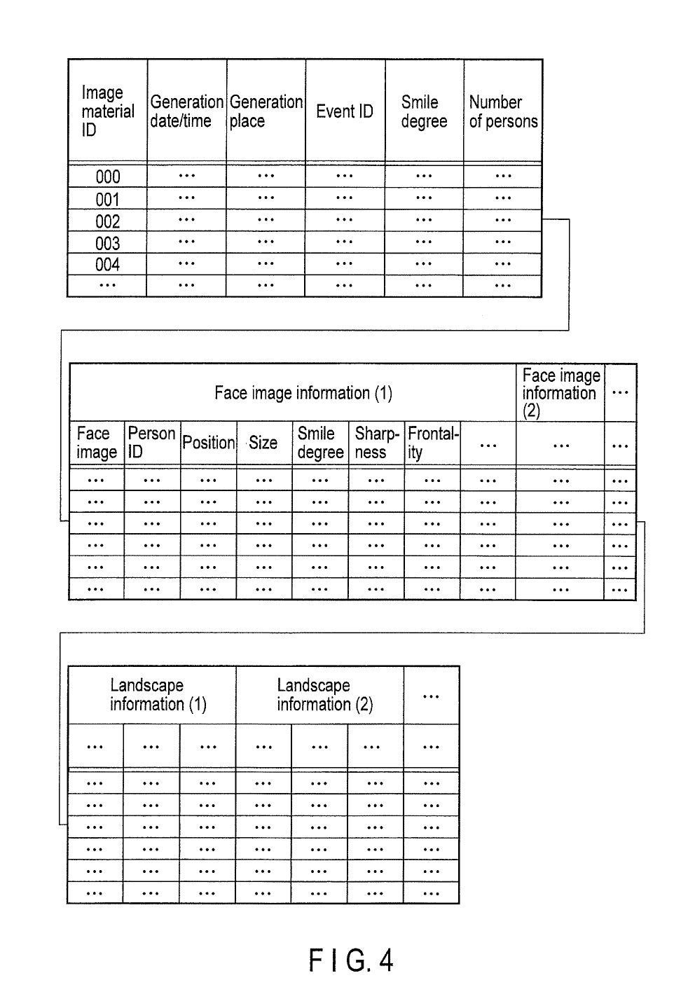

The material analysis module 42 analyzes attributes of images which are supplied by the material supply module 41, and stores an analysis result (analysis information) in the material database 24b. The details of the analysis by the material analysis module 42 will be described later (see FIG. 4).

The material select module 44 selects images, which are to be used in a composite moving picture, by using the analysis information (attributes of images) of the image material stored in the material database 24b, and notifies a selection result to the effect select module 45. Based on the analysis information of each image, the material select module 44 distinctively selects, for example, images including a target of interest which is designated by the user, and images not including the target of interest. In addition, the material select module 44 extracts images, which are relevant to the target of interest, from the image material data 24d, arranges the extracted plural images in a predetermined order, and classifies the images into a section of a group (target-of-interest image material group) including at least one image including the target of interest, and a section of a group (general image material group) including at least one image which does not include the target of interest.

The effect select module 45 selects, from the effect database 24c, effects which are used in an image effect process for images indicated by the selection result notified by the material select module 44, and notifies the selected effects to the composite moving picture generation module 47. For example, the effect select module 45 selects a target-of-interest scenario for the target-of-interest image material group, and selects a general scenario for the general image material group.

Responding to the notification from the effect select module 45, the composite moving picture generation module 47 takes out the information of all images, which are to be used for moving picture generation, from the material database 24b, generates a moving picture by applying an image effect process by the effects notified from the effect select module 45, and outputs the generated moving picture to the composite moving picture output module 48. A composite moving picture, which is generated from the composite moving picture generation module 47, is called, for example, “photo movie” or “slide show”. In addition, the composite moving picture generation module 47 can generate a moving picture in parallel with playback of a song, and generates a moving picture in accordance with a playback time of a song.

The composite moving picture output module 48 causes the LCD 13 to display the composite moving picture which has been generated by the composite moving picture generation module 47, or outputs the composite moving picture as a moving picture file.

Next, a description is given of an image processing method which is executed by the composite moving picture generation program 24a of the embodiment.

To begin with, analysis of images by the material analysis module 42 is described.

If images (still images, moving picture) are input from the camera unit 28, external memory 30 or the external device connected via the input terminal 29, the material supply module 41 stores the images in the memory 24 as the image material data 24d.

The material analysis module 42 analyzes attributes indicative of the characteristics of the images which are newly input by the material supply module 41. The material analysis module 42 may analyze the images each time an image is newly input by the material supply module 41, or at a predetermined timing, or at a timing designated by the user.

The material analysis module 42 includes, for example, a face recognition function of recognizing a person's face image area from an image. By the face recognition function, the material analysis module 42 can retrieve, for example, a face image area having a characteristic similar to a face image characteristic sample which is prepared in advance. The face image characteristic sample is characteristic data which is obtained by statistically processing face image characteristics of many persons. By the face recognition function, the position (coordinates) and size of a face image area included in an image are stored.

In addition, by the face recognition function, the material analysis module 42 analyzes image characteristics of the face image area. The material analysis module 42 calculates, for example, a smile degree, sharpness and frontality of a detected face image. The smile degree is an index indicative of a degree of a smile of the detected face image. The sharpness is an index indicative of a degree of sharpness of the detected face image. The frontality is an index indicative of a degree of frontality of the detected face image. The material analysis module 42 classifies face images on a person-by-person basis, and gives identification information (person ID) to each person.

In addition, the material analysis module 42 includes, for example, a landscape recognition function of recognizing a landscape (an image other than a person) form an image. The landscape recognition function, like the face recognition function, analyzes a characteristic similar to a characteristic sample of a landscape image, thereby being able to recognize the kind of a landscape, and an object (e.g. a natural object, a structural object) included in the landscape. In addition, the characteristic of a landscape image can be discriminated from a color tone or a composition of an image. The material analysis module 42 can detect, as attributes of an image, indices indicative of image characteristics which are discriminated by the landscape recognition function.

Besides, the material analysis module 42 can analyze attributes of an image, with respect to information added to the image as a target of analysis. For example, the material analysis module 42 identifies the date/time of generation (photographing date/time) of an image, and the place of generation of the image. Further, based on the date/time of generation (photographing date/time) and the place of generation of the image, the material analysis module 42 classifies the image, for example, into the same event as other still images generated in a predetermined period (e.g. one day), and givens event identification information (event ID) for each classification.

FIG. 4 is a view illustrating an example of the analysis information which is stored in the material database 24b by the material analysis module 42 in the embodiment.

As illustrated in FIG. 4, the analysis information includes a plurality of entries corresponding to a plurality of images. Each entry includes, for example, an image ID, a generation date/time (photographing date/time), a generation place (photographing place), an event ID, a smile degree, the number of persons, and face image information. The smile degree is indicative of information which is determined by totaling smile degrees of face images included in the image. The number of persons is indicative of a total number of face images included in the image.

The face image information is recognition result information of face images included in the image. The face image information includes, for example, a face image (e.g. a path (image material URL) indicative of a storage location of the face image), a person ID, a position, a size, a smile degree, sharpness, and frontality. Incidentally, when one image includes a plurality of face images, face image information (face image information (1), (2), . . . ) corresponding to each of the plural face images is included.

The landscape information is recognition result information of a landscape image included in the image. The landscape information includes, for example, a landscape image (e.g. a path (image material URL) indicative of a storage location of the landscape image), the kind of landscape (a landscape ID), and information indicative of an object (a natural object, a structural object) included in the landscape. Incidentally, when one image includes a plurality of landscape images, landscape image information (landscape information (1), (2), . . . ) corresponding to each of the plural landscape images is included.

Next, a description is given of the effect information which is stored in the effect database 24c in the embodiment.

In the effect database 24c, for example, a plurality of scenarios are prepared for each of a plurality of styles for classifying characteristics of images.

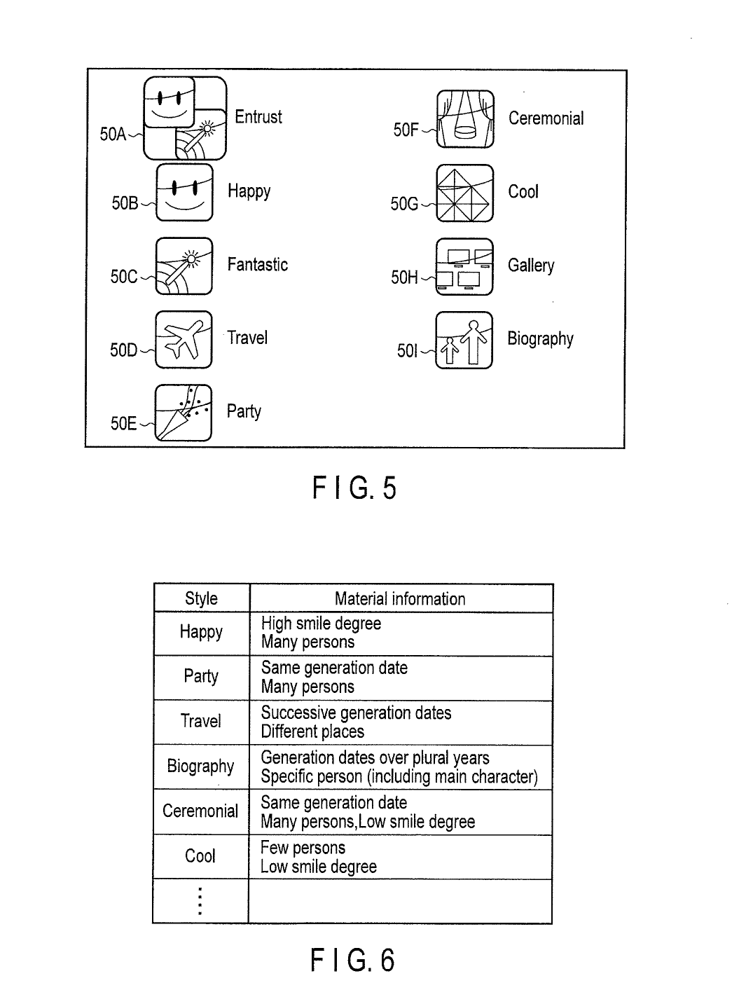

FIG. 5 is a view illustrating an example of a style select screen in the embodiment. When the electronic device 10 generates a moving picture by the composite moving picture generation program 24a, the electronic device 10 can display a style select screen shown in FIG. 5, and can prompt the user to designate the characteristic of the moving picture. In the effect database 24c, a plurality of scenarios corresponding to a plurality of styles, which are selectable on the style select screen, are prepared.

In the example illustrated in FIG. 5, a plurality of buttons 50B to 50I corresponding to, for example, eight styles (Happy, Fantastic, Ceremonial, Cool, Travel, Party, Gallery, Biography) are displayed. In the meantime, an “Entrust” button 50A is a button indicating that no specific style is designated.

FIG. 6 is a view illustrating an example of material information indicative of characteristics of image material corresponding to respective styles in the embodiment.

For example, for the style “Happy”, effects, which are applicable to images having attributes of “High smile degree” and “Many persons”, are prepared so that a moving picture, which evokes a happy impression or a cheerful impression, may be generated. In addition, for the style “Party”, effects, which are applicable to images having attributes of “Same generation date” and “Many persons”, are prepared. For the style “Travel”, effects, which are applicable to images having attributes of “Successive generation dates” and “Different generation places”, are prepared.

FIG. 7 is a view illustrating scenarios which are prepared for the respective styles in the embodiment.

As illustrated in FIG. 7, with respect to each of the styles, there are provided a target-of-interest scenario which is used for images including a target of interest, and a general scenario which is used for images not including the target of interest. In addition, a plurality of scenarios are prepared for each of the target-of-interest scenario and the general scenario, which correspond to one style. For example, the target-of-interest scenario of the style (Happy) includes scenarios A1-1, A1-2, . . . , and the general scenario includes scenarios B1-1, B1-2, . . . .

In the target-of-interest scenario, effects (target-of-interest effects), with which an image effect process can be executed with attention paid to a target of interest, can be defined. In addition, in the general scenario, effects (general effects), with which an image effect process with a high visual effect can be executed for the entire image, with no attention paid to details of an image material such as a target of interest, can be defined. By providing the target-of-interest scenario which is used for images including a target of interest, and the general scenario which is used for images not including the target of interest, the scenarios are selectively used for images which are used in compositing a moving picture. Thereby, an image effect process, which is suitable for each material image, can be executed without unnaturalness. Therefore, it is possible to generate a moving picture without unnaturalness, to which effects that are effective in the entire moving picture are applied, the effects including effects with attention paid to the target of interest.

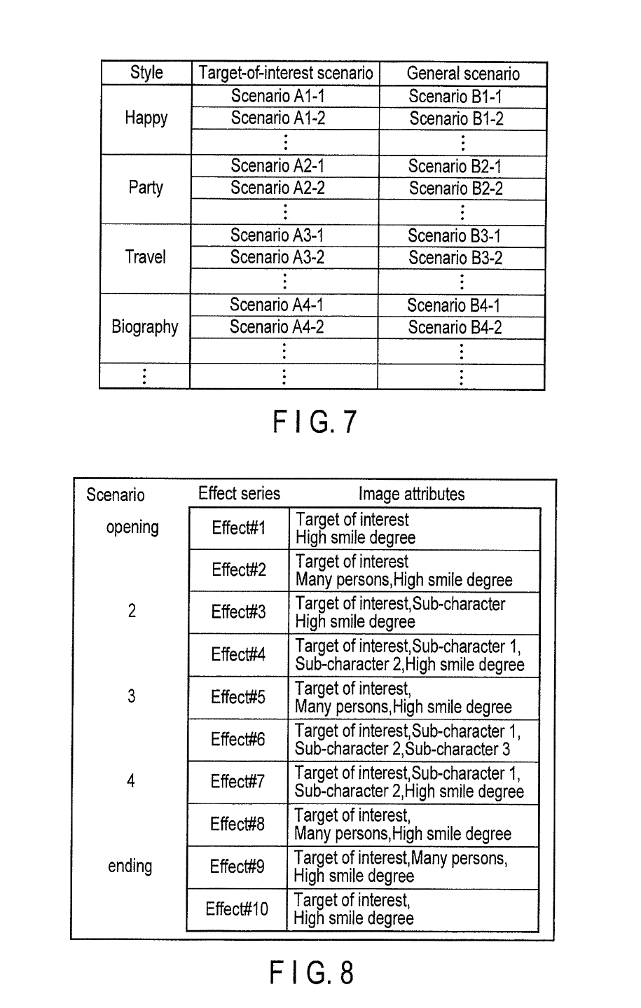

FIG. 8 is a view illustrating an example of one scenario in the embodiment. The scenario illustrated in FIG. 8 is, for example, a target-of-interest scenario of the style (Happy).

As illustrated in FIG. 8, in the scenario, a plurality of effects (Effect#1, Effect#2, . . . ) are defined in a predetermined order of use in the image effect process. In one effect, one kind of effect, or an effect series, in which a plurality of effects are combined, is defined. In addition, in each effect, image attributes, to which each image effect process is applicable, are set.

For example, as regards image attributes relating to the effect (Effect#1) shown in FIG. 8, since the scenario is the target-of-interest scenario, an image, which includes a target of interest and has a high smile degree of a face image included in the image, is set so as to adapt to the style (Happy). Referring to the image attributes that are set for the effect, the material select module 44 can determine whether the effect in the scenario is applicable to the images which are used in generating the moving picture.

In the meantime, if many attributes are not set for an effect, the effect is applicable to an image effect process for many material images.

Similarly, as regards the effects of the scenarios corresponding to other styles, for example, in the style “Ceremonial”, image attributes indicative of an image with many persons and a low smile degree are set. In the style “Fantastic”, image attributes indicative of an image with few persons and a high smile degree are set.

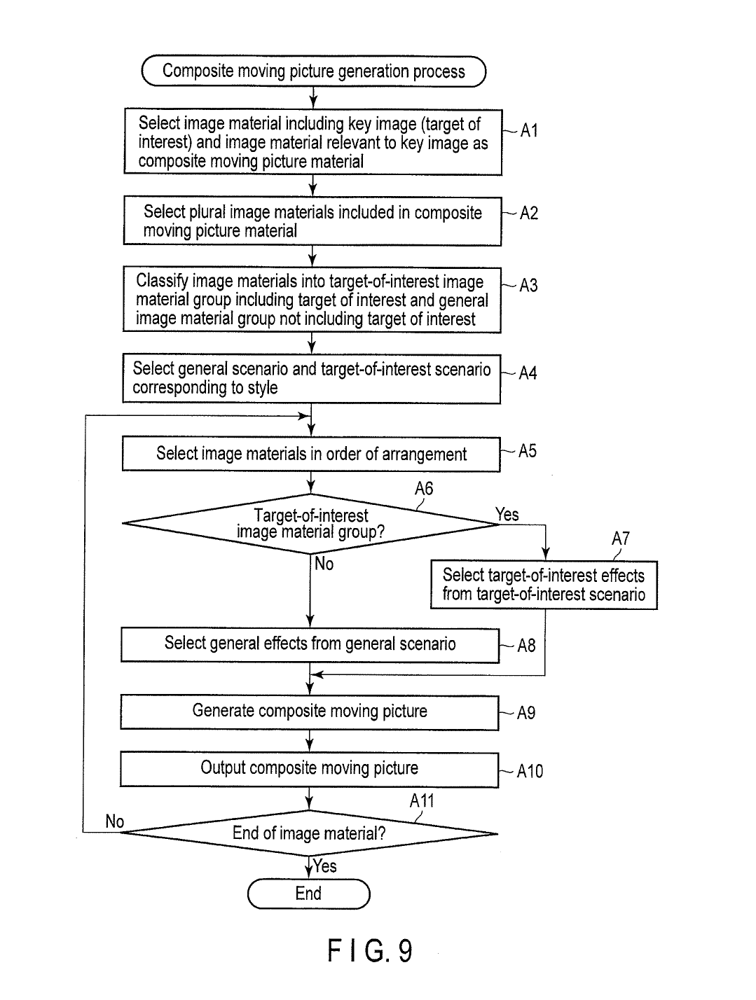

Next, referring to a flowchart of FIG. 9, a description is given of a composite moving picture generation process by the composite moving picture generation program 24a in the embodiment.

To begin with, if the composite moving picture generation program 24a is started by a user operation, the electronic device 10 causes a main screen to be displayed. On the main screen, for example, “style”, “song”, “main character” (target of interest) can be set by a user operation.

For example, if a “style” button displayed in the main screen is selected, the processor 20 causes a style select screen, as shown in FIG. 5, to be displayed. The style select screen includes an “Entrust” button 50A, and a plurality of buttons 50B to 50I corresponding to the above-described eight styles (Happy, Fantastic, Ceremonial, Cool, Travel, Party, Gallery, Biography). By selecting a desired button, the user can designate the style. In the meantime, by designating the “Entrust” button 50A, a style corresponding to characteristics of plural images, which are used for image display, is automatically selected.

In addition, if a “song” button displayed in the main screen is selected, the processor 20 causes a song list (song select screen) to be displayed. On the song select screen, a song, which is output in parallel with playback of a moving picture, can be selected by a user operation.

Furthermore, if a “main character” button displayed in the main screen is selected, the processor 20 causes a face image select screen for selecting a key face image (target of interest) to be displayed. The face image select screen displays a list of face images which can be designated as a target of interest. The list of face images displays, for example, face images of persons with a higher number of occurrences than a preset value in plural images included in the image material data 24d, the face images of persons being determined based on an analysis result by the material analysis module 42. Using the face image select screen, the user selects a face image (target of interest) of a person of interest from the list of face images. Incidentally, the number of face images, which are selected, may be plural. In addition, when the user does not select a face image, a face image may be automatically selected from the list of face images in accordance with a predetermined condition. In the meantime, the key image (target of interest) may not only be selected from the list of face images, but the key image (target of interest) may also be designated by the user from images which are being displayed.

In this manner, if the “style”, “song” and “main character” (target of interest) are set by user operations and generation of a moving picture is instructed by, for example, an operation of a “start” button, the processor 20 starts generation of a moving picture by the composite moving picture generation program 24a.

To begin with, the material select module 44 selects image material including a key image (target of interest) and image material relevant to the key image as composite moving picture material which is used for the generation of a moving picture, based on analysis information indicative of image characteristics stored in the material database 24b (block A1).

It is assumed that the image material relevant to the key image has attributes indicative of relevance with respect to, for example, a photographing date/time (generation date/time), a person, and a place. The image material relevant to the key image does not necessarily include the key image.

As regards the relevance with respect to the photographing date/time (generation date/time), it is assumed that those images, other than the image including the key image, which were generated during the same period (e.g. a period designated by a day, a month, a season, a time of year, a season, or a year) as the generation date/time of the image including the key image, have relevance to the key image. In addition, it may be assumed that images, which were generated in the same day, the same week, the same month, etc. (e.g. the same day of the previous year, or the same month two years later) during a period different from the generation date/time of the key image, have relevance to the key image.

As regards the relevance with respect to the person, for example, it is assumed that images including a face image of the same person as the key face image, and images including a face image of another person included in the same image as the key face image, have relevant to the key image. As regards the place, it is assumed that images, which were generated at a place relevant to the generation place of the image including the key image, have relevance to the key image.

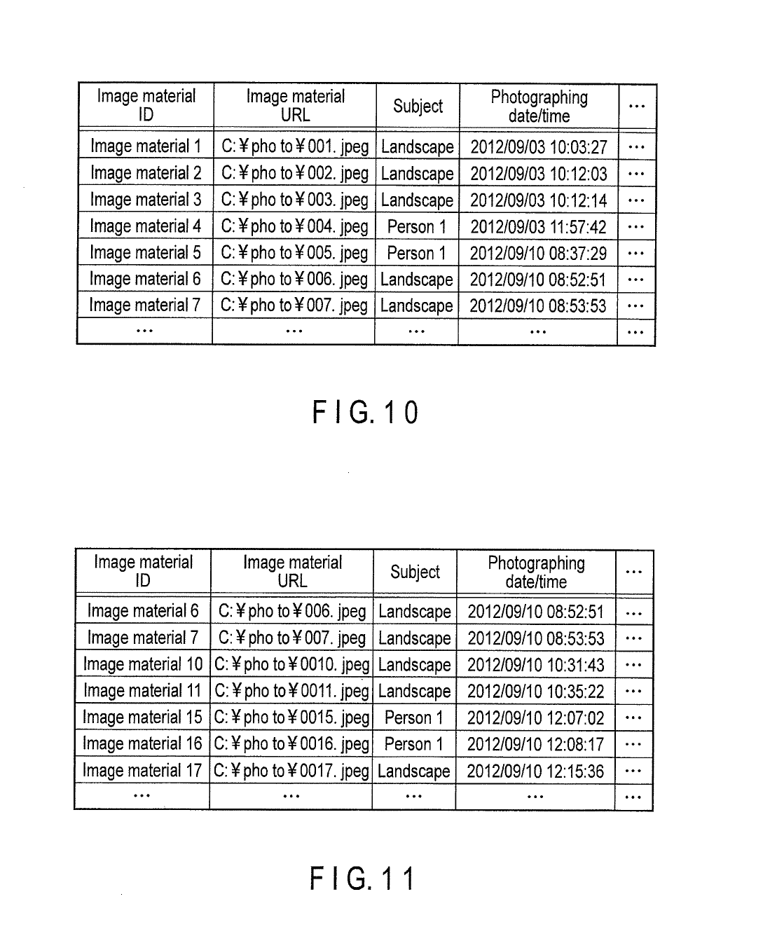

FIG. 10 is a view illustrating an example of the analysis information which is stored in the material database 42b. FIG. 10 shows, of the analysis information, for example, an image material ID, an image material URL, a subject (person ID, landscape ID), and a photographing date/time.

FIG. 11 is a view illustrating a selection result by the material select module 44, based on the analysis information illustrated in FIG. 10. In the example shown in FIG. 11, it is indicated that a plurality of images of landscapes and images including “person 1” that is a key image (target of interest) have been selected as composite moving picture material.

Next, the effect select module 45 arranges in a predetermined order a plurality of images included in the composite moving picture material selected by the material select module 44 (block A2). For example, as illustrated in FIG. 11, the effect select module 45 arranges a plurality of images in an order of photographing dates/times. Incidentally, plural images included in the composite moving picture material may be arranged based on other attributes.

Subsequently, the effect select module 45 classifies the plural images, which are arranged in the predetermined order, into a target-of-interest image material group which includes the target of interest and a general image material group which does not include the target of interest (block A3).

In the example shown in FIG. 11, image materials ID 15 and ID 16 are grouped as the target-of-interest image material group, and image materials ID 6, ID 7, ID 10, ID 11 and ID 17 are grouped as the general image material group.

Next, the effect select module 45 selects, from the effect database 24c, a general scenario and a target-of-interest scenario for an image effect process on the composite moving picture material, in accordance with the style selected by the user (block A4). Incidentally, the effect select module 45 may select not only one general scenario and one target-of-interest scenario, but also a plurality of general scenarios and a plurality of target-of-interest scenarios.

Then, the effect select module 45 selects image material in an order of arrangement from a plurality of images included in the composite moving picture material (block A5), and selects effects included in either the general scenario or the target-of-interest scenario. Specifically, when the image material is included in the target-of-interest image material group (Yes in block A6), the effect select module 45 selects target-of-interest effects from the target-of-interest scenario (block A7). On the other hand, when the image material is not included in the target-of-interest image material group (No in block A6), the effect select module 45 selects general effects from the general scenario (block A8).

In the meantime, when the effect select module 45 selects image material from a plurality of images included in the composite moving picture material, the effect select module 45 may select not only each single image material, but also a plurality of successive image materials.

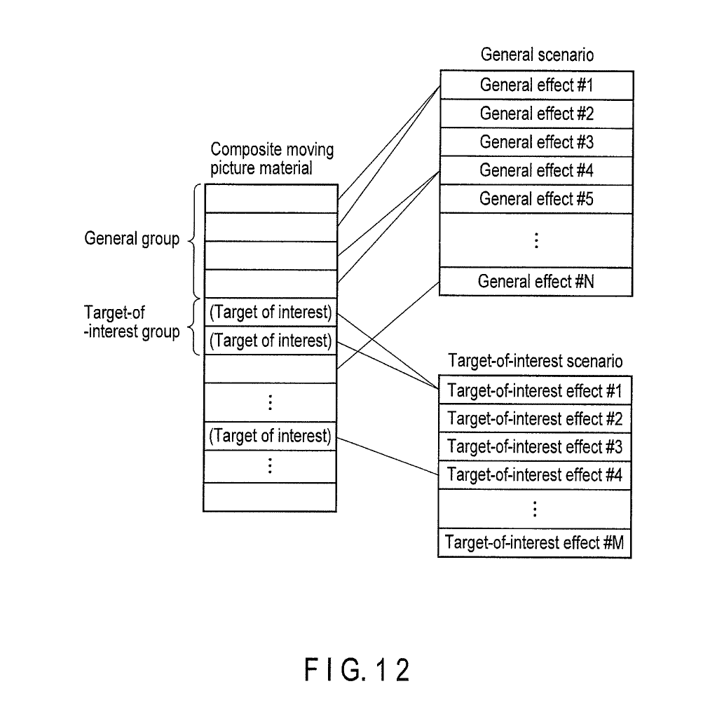

FIG. 12 is a view for explaining selection of effects by the effect select module 45.

As illustrated in FIG. 12, general effects included in a general scenario are selected for material images included in a general group. Basically, effects are selected in an order of arrangement in the scenario. However, referring to the attributes of image material and image attributes of effects, an effect, which is determined to be unsuitable for the image material, is not selected, and the next effect in the order of arrangement is selected. If many attributes are not set as image attributes of effects, effects which are suitable for the image material can be selected in a short time.

Similarly, target-of-interest effects included in a target-of-interest scenario are selected for material images included in a target-of-interest group.

In addition, each of the general effects and target-of-interest effects may be applied to not only one image material but also to a plurality of image materials, and thereby an effect, which brings about a high visual effect with a combination of plural image materials, can be realized.

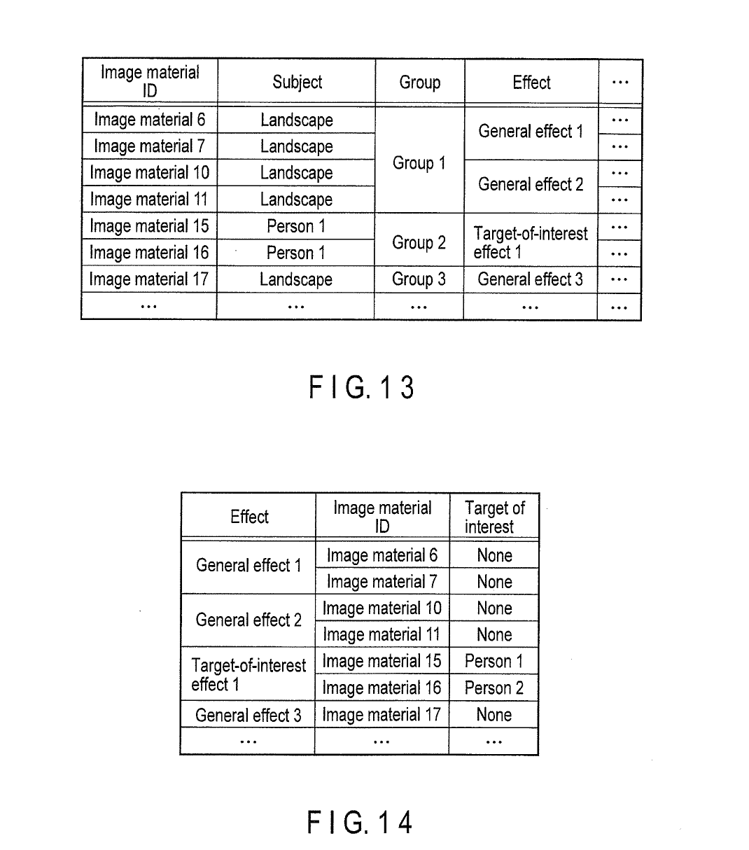

FIG. 13 is a view illustrating a selection result of effects by the effect select module 45.

In the example shown in FIG. 13, it is indicated that as regards the general image material group (image materials ID 6, ID 7, ID 10, ID 11 and ID 17), a general effect 1 is selected for image materials ID 6 and ID 7, a general effect 2 is selected for image materials ID 10 and ID 11, and a general effect 3 is selected for image material ID 17.

In addition, it is indicated that as regards the target-of-interest image material group, a target-of-interest effect 1 is selected for image materials ID 15 and ID 16.

The effect select module 45 notifies composite moving picture information, which is indicative of the effects that are applied to the image material, to the composite moving picture generation module 47.

FIG. 14 is a view illustrating an example of the composite moving picture information which is notified from the effect select module 45 to the composite moving picture generation module 47.

As illustrated in FIG. 14, composite moving picture information is output, which indicates that the general effect 1 is applied to the image materials ID 6 and ID 7, and the general effect 2 is applied to the image materials ID 10 and ID 11.

Upon receiving the composite moving picture information from the effect select module 45, the composite moving picture generation module 47 takes out the information of the image material, which is to be used in compositing a moving picture, from the material database 24b, generates the composite moving picture, and delivers the composite moving picture to the composite moving picture output module 48 (block A9). Specifically, the composite moving picture generation module 47 generates images by applying general effects to the image material included in the general image material group, generates images by applying target-of-interest effects to the image material included in the target-of-interest image material group, and composites these images, thereby generating a moving picture.

The composite moving picture output module 48 outputs the composite moving picture which has been generated by the composite moving picture generation module 47 (block A10). For example, the composite moving picture output module 48 causes the LCD 13 to display the composite moving picture.

If the output of the composite moving picture based on all image materials included in the composite moving picture material has not been completed (No in block A11), the processor 20 repeatedly executes the same process as described above (blocks A5 to A11).

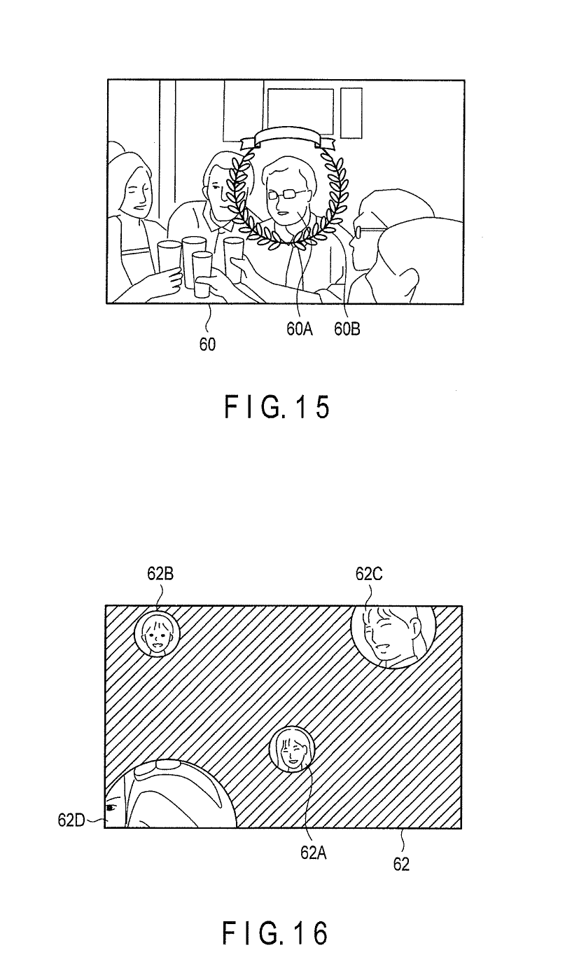

FIG. 15 and FIG. 16 are views illustrating scenes of the moving picture which is composited.

An image 60 shown in FIG. 15 includes a face image 60A of a person designated as a target of interest (key image). Thus, a target-of-interest effect is selected by the effect select module 45, and an effect 60B is applied with attention paid to the face image 60A.

An image 62 shown in FIG. 16 does not include a face image of a person designated as a target of interest (key image), but includes face images of a plurality of persons. Thus, a general effect for an image including a plurality of persons is selected by the effect select module 45, and an image effect process is applied with a high visual effect using all face images 62A, 62B, 62C and 62D of the plural persons.

In the meantime, when an output of a song is designated in parallel with display of a composite moving picture, the processor 20 continues generation of the moving picture in accordance with a length (playback time) of the song that is a target of playback. In the case where the playback of the song does not end at a time when the generation of the moving picture with use of all image materials included in the composite moving picture material has been completed, the processor 20 generates a moving picture, for example, by repeatedly using a plurality of material images included in the same composite moving picture material. In addition, when the material images are repeatedly used, the arrangement of material images is altered (shuffled) according to a predetermined condition. Thereby, the order of material images used in the moving picture generation can be changed, and the content of the output moving picture can be varied.

Each time the composite moving picture material is repeatedly used, different scenarios may be selected from the general scenario and target-of-interest scenario. Thereby, even if the same image material is used, a moving picture with different effects can be generated.

In the flowchart of FIG. 9, the moving picture is generated while plural image materials included in the composite moving picture material are being selected in the order of arrangement. However, the moving picture may be generated batchwise after effects have been selected for all of plural image materials included in the composite moving picture material. For example, when the generation of a moving picture has been instructed by the user, if it is not necessary to immediately output (display) the moving picture, the moving picture is generated batchwise after selecting effects for all of plural image materials.

In this manner, in the electronic device 10 of the embodiment, image materials including a target of interest and image materials not including the target of interest are classified into the target-of-interest image material group and general image material group, respectively. By selecting effects, which are to be actually applied, from candidates of effects suitable for the respective groups, the effect select process can be simplified and an increase in speed of the effect select process can be expected.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

What is claimed is:

1. An electronic device comprising:
an analyzer configured to analyze an attribute of each of a plurality of images;
an image selector configured to select, from the plurality of images, a first image which comprises a target and a second image which does not comprise the target, based on the attribute;
an effect selector configured to select a first effect, and to select a second effect; and
a generator configured to generate a moving picture by compositing a third image obtained by applying the first effect to the first image, and a fourth image obtained by applying the second effect to the second image.

2. The electronic device of claim 1, further comprising a classification module configured to classify the plurality of images into a first group comprising first images, and a second group comprising second images,
wherein the generator is configured to generate the third image by applying the first effect to the first images in the first group, and to generate the fourth image by applying the second effect to the second images in the second group.

3. The electronic device of claim 2, further comprising a storage configured to store a first scenario wherein a plurality of first effects are defined, and a second scenario wherein a plurality of second effects are defined,
wherein the effect selector is configured to select the first effect from the first scenario, and to select the second effect from the second scenario.

4. The electronic device of claim 3, further comprising a style selector configured to select a style,
wherein the storage is configured to store a plurality of first scenarios corresponding to a plurality of styles, and a plurality of second scenarios corresponding to the plurality of styles, and
the effect selector is configured to select the first effect and the second effect from the first and second scenarios corresponding to a style selected by the style selector.

5. The electronic device of claim 1, wherein the image selector is configured to arrange the plurality of images in a predetermined order, and to select the first image and the second image in an order of the arrangement, and
the image selector is configured to change the arrangement after the first image and the second image are selected.

6. An image processing method comprising:
analyzing an attribute of each of a plurality of images;
selecting, from the plurality of images, a first image which comprises a target and a second image which does not comprise the target, based on the attribute;
selecting a first effect, and selecting a second effect; and
generating a moving picture by compositing a third image obtained by applying the first effect to the first image, and a fourth image obtained by applying the second effect to the second image.

7. A computer-readable, non-transitory storage medium having stored thereon a computer program which is executable by a computer, the computer program controlling the computer to execute functions of:
analyzing an attribute of each of a plurality of images;
selecting, from the plurality of images, a first image which comprises a target and a second image which does not comprise the target, based on the attribute;
selecting a first effect, and selecting a second effect; and
generating a moving picture by compositing a third image obtained by applying the first effect to the first image, and a fourth image obtained by applying the second effect to the second image.
